(19) United States
(12) Patent Application Publication
(10) Pub. No.: US 2019/0233777 A1
(43) Pub. Date: Aug. 1, 2019

(54) MICROEMULSION REMOVERS FOR ADVANCED PHOTOLITHOGRAPHY

(71) Applicants: Dow Global Technologies LLC, Midland, MI (US); Rohm and Haas Electronic Materials LLC, Marlborough, MA (US)

(72) Inventors: Adam K. Schmitt, Midland, MI (US); Carol E. Mohler, Midland, MI (US); Kathleen M. O'Connell, Cumberland, RI (US); Christopher J. Tucker, Midland, MI (US); Zhijian Lu, Boxborough, MA (US); Shintaro Yamada, Shrewsbury, MA (US)

(21) Appl. No.: 15/883,141

(22) Filed: Jan. 30, 2018

(51) Int. Cl. C11D 17/00; C11D 3/43; C11D 3/30; C11D 3/04; C11D 3/39; C11D 1/00

(52) U.S. Cl. CPC C11D 17/0021; C11D 3/43; C11D 1/002; C11D 3/044; C11D 3/3942; C11D 3/30

(57) ABSTRACT

The present invention provides a microemulsion remover comprising, based on the total weight of the microemulsion remover, 1) from 10% to 60%, at least one organic solvent, ii) from 10% to 50%, at least one co-solvent, iii) from 0.1% to 10%, at least one base, iv) from 0.1% to 10%, at least one oxidizer, v) from 0.1% to 10%, at least one surfactant, and vi) water.

### FIELD OF THE INVENTION

The present invention relates to a microemulsion remover allowed for removal of polymeric films used in advanced photolithography schemes such as tri-layer stacks, particularly pre- and post-etch SiARC films.

### INTRODUCTION

Advanced lithographic techniques necessitate the use of complicated patterning schemes such as tri-layer resist systems that consist of a photoresist layer, a high silicon content anti-reflection coating (SiARC), and a high carbon content underlayer. Although this tri-layer stack enables the patterning of features at the 10 nm node, the wet removal of these films after photolithographic processing, particularly the SiARC film, poses a significant challenge due to the high level of crosslinking and silicon content in the film. The removal of these films typically requires exposure to high levels of aggressive bases and oxidants such as ammonium hydroxide and hydrogen peroxide. These chemistries can remove low silicon content SiARC films at elevated temperatures, but result in substantial damage to other sensitive features, and are unable to remove higher silicon content SiARC layers. Thus the most critical requirement of new wet removal chemistries is the complete removal of tri-layer resist stacks with no adverse effects to the substrate in front end applications, or the ultralow-k dielectrics in back end applications.

In addition to SiARC films, it is also important to effectively remove a wide range of polymeric films typically used in advanced lithography, without damaging adjacent structures or ultimately affecting device performance This includes photoresist films, topcoat films, organic polymer films such as high carbon content underlayers and combinations of one or more of the above films; removal of polymeric films that are crosslinked, or not crosslinked, films that are thermally cured, and films that are cured with UV light irradiation. Also included are films that are to be removed following their use as a barrier during a plasma etch process (plasma compoisitions such as chlorine, bromine, fluorine, oxygen, ozone, hydrogen, SO₂, argon, CO and XeF₂), and films that are to be removed after their use as barriers to ion implantation (boron, phosphorus and arsenic ions).

It is therefore desired in the art a new remover allowed for removal of all these polymeric films used in advanced photolithography schemes.

### SUMMARY OF THE INVENTION

The present invention provides a microemulsion remover comprising, based on the total weight of the microemulsion remover, i) from 10% to 60%, at least one organic solvent, ii) from 10% to 50%, at least one co-solvent, iii) from 0.1% to 10%, at least one base, iv) from 0.1% to 10%, at least one oxidizer, v) from 0.1% to 10%, at least one surfactant, and vi) water. The organic solvents include aliphatic alcohols and aromatic alcohols with water solubility less than 10%, dialiphatic esters, aliphatic hydrocarbons, aromatic hydrocarbons, aliphatic diesters, aliphatic ketones with water solubility less than 10% at 21° C., and aliphatic ethers; and the co-solvents include aliphatic alcohols with water solubility greater than 10% at 21° C.

### DETAILED DESCRIPTION OF THE INVENTION

The invention described here is a stripping formulation for polymeric films which uses oil continuous microemulsions with chemistries such as ammonium hydroxide and hydrogen peroxide incorporated into the water phase. Without being committed to it, the hypothesis is advanced that the organic continuous phase in these microemulsions swells the polymeric film and aids in physical removal of the film, while the water phase which contains the removal chemistries (ammonium hydroxide, hydrogen peroxide), is transported into the swollen film and delivers the remover chemistries throughout the film to effectively dissolve it. The concentration of aggressive removal chemicals needed to remove the polymeric film is greatly reduced, resulting in less damage to surrounding structures during the removal process.

The microemulsions claimed are comprised of several components including one or more organic solvents to provide the oil continuous phase and to swell the polymeric film, at least one co-solvent having less than 10% water miscibility to provide the low interfacial tension needed to form the microemulsion, oxidizer and base to dissolve the polymeric film, water to form the aqueous part of the microemulsion and to solubilize the oxidant and base, and surfactant to stabilize the aqueous-organic solvent interface. In some cases a neutralizer such as an alcohol amine is needed to neutralize the acid functionality of the surfactant.

The microemulsion remover of the present invention comprises, based on the total weight of the microemulsion remover, i) from 10% to 60%, preferably from 20% to 50%, and more preferably from 30% to 45%, at least one organic solvent, ii) from 10% to 50%, preferably from 12% to 40%, and more preferably from 15% to 30%, at least one co-solvent, iii) from 0.1% to 10%, preferably from 0.5% to 6%, and more preferably from 1% to 3%, at least one base, iv) from 0.1% to 10%, preferably from 1% to 8%, and more preferably from 3% to 5%, at least one oxidizer, v) from 0.1% to 10%, preferably from 1% to 8%, and more preferably from 3% to 6%, at least one surfactant, and vi) water.

Preferred classes of organic solvents that can be used in the practice of this invention include aliphatic alcohols and aromatic alcohols with water solubility less than 10% at 21° C., dialiphatic esters, aliphatic hydrocarbons, aromatic hydrocarbons, aliphatic diesters, aliphatic ketones with water solubility less than 10% at 21° C., and aliphatic ethers. Alternately preferred solvents include aliphatic or aromatic keto-esters, aliphatic or aromatic keto-alcohols, and aromatic or aliphatic ester-alcohols.

The aliphatic alcohols can be primary, secondary or tertiary. Preferred aliphatic alcohols have 4 to 24 carbon atoms. Representative examples of more preferred aliphatic alcohols include octanol, 2-ethyl-hexanol, nonanol, dodecanol, undecanol, and decanol.

The aromatic alcohols can be primary secondary or tertiary. Preferred aromatic alcohols have 4 to 24 carbon atoms. Representative examples of more preferred aliphatic alcohols include benzyl alcohol, phenyl alcohol, ethylene glycol monophenyl ether, and propylene glycol monophenyl ether.

Preferred dialiphatic esters have 4 to 24 carbon atoms. Representative examples of more preferred dialiphatic esters include methyl laurate, methyl oleate, hexyl acetates, pentyl acetates, octyl acetates, nonyl acetates, and decyl acetates.

The aliphatic hydrocarbons can be linear, branched, cyclic or combinations thereof.

Preferred aliphatic hydrocarbons contain 3 to 24 carbon atoms, preferably 6 to 24 carbon atoms. Representative examples of more preferred aliphatic hydrocarbons include alkanes such as liquid propane, butane, hexane, octane, decane, dodecane, hexadecane, mineral oils, paraffin oils, decahydronaphthalene, bicyclohexane, cyclohexane, and olefins such as 1-decene, 1-dodecene, octadecene, and hexadecene. Examples of commercially available aliphatic hydrocarbons are NORPAR™ 12, 13, and 15 (normal paraffin solvents available from Exxon Corporation), ISOPAR™ G, H, K, L, M, and V (isoparaffin solvents available from Exxon Corporation), and SHELLSOL™ solvents (Shell Chemical Company).

Preferred aromatic hydrocarbons contain 6 to 24 carbon atoms. Representative examples of more preferred aromatic hydrocarbons include toluene, napthalene, biphenyl, ethyl benzene, xylene, alkyl benzenes such as dodecyl benzene, octyl benzene, and nonyl benzene.

Preferred aliphatic diesters contain 6 to 24 carbon atoms. Representative examples of more preferred aliphatic diesters include dimethyl adipate, dimethyl succinate, dimethyl glutarate, diisobutyl adipate, and diisobutyl maleate.

Preferred aliphatic ketones have 4 to 24 carbon atoms. Representative examples of more preferred aliphatic ketones include methyl ethyl ketone, diethyl ketone, diisobutyl ketone, methyl isobutyl ketone, and methyl hexyl ketone.

Preferred aliphatic ethers have 4 to 24 carbon atoms. Representative examples of more preferred aliphatic ethers include diethyl ether, ethyl propyl ether, hexyl ether, butyl ether, and methyl t-butyl ether.

Representative examples of more preferred organic solvents include propylene glycol monomethyl ether acetate, dipropylene glycol monomethyl ether acetate, tripropylene glycol mono n-butyl ether, propylene glycol phenyl ether, propylene glycol diacetate, dipropylene glycol dimethyl ether, dithelyne glycol-butyl ether acetate, ethylene glycol n-butyl ether acetate, and ethylene glycol phenyl ether.

The most preferred classes of organic solvents are propylene glycol phenyl ether and ethylene glycol phenyl ether.

Preferred classes of co-solvents that can be used in the practice of this invention include aliphatic alcohols with water solubility greater than 10%. In addition, a co-solvent can contain two or more of these functional groups or can contain combinations of these functional groups.

Representative examples of more preferred co-solvents include propylene glycol monomethyl ether, dipropylene glycol monomethyl ether, tripropylene glycol monomethyl ether, propylene glycol n-propyl ether, dipropylene glycol n-propyl ether, propylene glycol n-butyl ether, dipropylene glycol n-butyl ether, diethylene glycol ethyl ether, diethylene glycol methyl ether, diethylene glycol n-butyl ether, ethylene glycol propyl ether, ethylene glycol n-butyl ether, triethylene glycol monomethyl ether, triethylene glycol ethyl ether, and triethylene glycol n-butyl ether.

The most preferred co-solvents are triethylene glycol monomethyl ether, tripropylene glycol monomethyl ether, and dipropylene glycol monomethyl ether.

In the single phase oil continuous microemulsions, one or more ionic surfactants are employed which are soluble in the one or more organic solvents. The one or more ionic surfactants may also be characterized as possessing greater solubility in the one or more organic solvents than in water and preferentially partitioning into the organic solvent in a mixture of water and organic solvent. Typically, the one or more ionic surfactants are no more than sparingly water soluble. Here solubility does not include dispersability or emulsifiability. The one or more ionic surfactants have a molecular weight greater than 350 and less than 700. If two or more ionic surfactants are employed, “molecular weight” as used above is calculated based on the average of the molecular weights of the two or more ionic surfactants.

Useful anionic surfactants are employed which are soluble in the one or more organic solvents and no more than sparingly soluble in water and include salts of alkyl benzene sulfonates, alkyl toluene sulfonates, alkyl naphthyl sulfonates, petroleum sulfonates, alkyl sulfates, alkyl polyethoxy ether sulfates, paraffin sulfonates, alpha-olefin sulfonates, alpha-sulfocarboxylates and esters thereof, alkyl glyceryl ether sulfonates, fatty acid monoglyceride sulfates and sulfonates, alkyl phenol polyethoxy ether sulfates, 2-acyloxy-alkane-1-sulfonate, fatty acid salts, sulfated oils such as sulfated castor oil, and beta-alkyloxy alkane sulfonate.

A preferred class of ionic surfactants are anionic surfactants of formula RₓB—SO₃M, wherein R represents alkyl, x is 1 or 2, B is a biradical when x is 1 or is a triradical when x is 2 and which is derived from an aromatic moiety and wherein M represents hydrogen or a cationic counterion and wherein the total number of carbons in the anionic surfactant of formula RₓB—SO₃M is from 18 to 30. Preferably at least one anionic surfactant is of this formula. Molecular weight of an anionic surfactant of formula RxB—SO₃M is calculated exclusive of the molecular weight of M; that is, molecular weight is calculated for RxB—SO₃ only. The anionic surfactants containing M as a counterion can be readily prepared from surfactants wherein M is hydrogen such as by reacting the sulfonic acid with a metal hydroxide including hydroxides of ammonium, lithium, sodium, potassium, magnesium, calcium. Selection of a particular M counterion is not critical so long as the resulting surfactant remains soluble in the organic solvent and no more than sparingly water soluble and provides anionic surfactants which are capable of producing the microemulsions of this invention. Preferably, M is monovalent. Preferably, B is derived from benzene, toluene or naphthalene. Preferably, the anionic surfactants have a molecular weight greater than 400. Preferably, the anionic surfactants have a molecular weight less than 600 and more preferably less than 550.

Preferably, the preferred anionic surfactants are present in the microemulsions in an amount greater than 0.5 weight percent. Preferably, the preferred anionic surfactants are present in the microemulsions in an amount less than 10 percent and more preferably in an amount less than 8 percent.

The microemulsions of this invention contain one or more organic or inorganic bases. Preferred bases are chosen from alkaline metal hydroxides, organic ammonium hydroxides, or alkanol amines. These bases include potassium hydroxide, sodium hydroxide, and ammonium hydroxide. Also included are quaternary ammonium hydroxides where the alkyl groups can be a combination of one or more alkyl groups chosen from methyl, ethyl, propyl, or butyl in linear or branched forms. Alkanol amines include monoalkanol amines, dialkanol amines, and trialkanol amines, where the alkanol groups can be one or more of methanol, ethanol, propanol, or butanol in linear or branched forms. Most preferred bases are those free of alkaline metals and include ammonium hydroxide, organic quaternary ammonium hydroxides, and alkanol amines, specifically ethanolamines

The microemulsions of this invention also contain one or more oxidizers. Typical oxidizers include organic or inorganic peroxides, ozone, dissolved oxygen, acids, and halogen gases. The preferred oxidizers of this invention are chosen from hydrogen peroxide, ozone, oxygen, hypochlorous acid, fluorine, and chlorine. The most preferred oxidizer of this invention is hydrogen peroxide.

The present invention in one embodiment, is a microemulsion remover wherein the components or the solution have been treated with ion exchange resins or purified by distillation to remove trace metal cation contaminants to parts per billion or per trillion levels, and filtered to remove particles down to 0.01-0.2 microns.

The present invention in another embodiment, is a method of removing a polymeric film by applying the microemulsion remover solution through immersion either with or without rotation of the of the coated wafer in a bath of remover solution whether in an open or closed container, using mechanical agitation of the bath by stirring, blade or bubble shower, or ultrasonic agitation of the bath, with bath temperatures ranging from 20° C. to 80° C. The microemulsion remover may also be applied by puddle on a single wafer coating followed by spin-off, by a spray rinse process, by rotating drum spray process, by high or low impingement. The microemulsion remover may also be used in recycle/recapture system whereby new remover solution is added periodically to refresh the bath or spray reservoir and maintain the proper ratios of solvent, co-solvent, surfactant and water. The microemulsion remover may be used in a removal process that is either manual, automated, robotically automated, under computer or remote electronic control.

### EXAMPLES

I. Raw Materials

| Chemical | Function | Source |
|---|---|---|
| DOWANOL ™ PPh | Organic solvent | The Dow Chemical Company |
| Glycol Ether | | |
| Methoxytriglycol | Co-solvent | The Dow Chemical Company |
| Monoethanol amine | Neutralizer | The Dow Chemical Company |
| Ammonium hydroxide | Base | Sigma-Aldrich |
| Hydrogen peroxide | Oxidizer | Fisher Scientific |
| Linear alkylbenzene | Surfactant acid | Alfa Aesar |
| sulfonic acid | | |

II. Example Preparations

1. Surfactant Complex Preparation

The surfactant employed is a monoethanol amine neutralized linear alkylbenzene sulfonic acid. The surfactant was prepared by mixing monoethanol amine (12.9 g) with DI water (320.53 g) in a glass jar with stirring. Linear alkylbenzene sulfonic acid (67.3 g) was slowly added while stirring. The surfactant complex was stirred for 30 minutes after the addition was complete.

2. Remover Solution Preparation

The remover solutions were prepared manually by weighing each component into plastic cups. For the solutions containing hydrogen peroxide, the formulation was first prepared without the hydrogen peroxide. Right before testing, the remover solutions were preheated to the test temperature (usually 60° C.) in a 65° C. oven. The hydrogen peroxide solution was added volumetrically to the pre-heated remover solutions and they were placed back in the oven for 3 minutes and immediately used for film removal testing.

Comparative microemulsion remover examples 1 to 9 (Comp. 1 to 9) and Inventive microemulsion remover examples 1 to 7 (Inv. 1 to 7) are prepared using the components listed in below Tables 1 to 3.

3. Preparation of Films for Removal Test

A SiARC solution was prepared as described in a patent literature (Sample-A in U.S. Pat. No. 9,442,377 B). The silicon content of SiARC sample-A is approximately 18 weight %. SiARC sample-A was spin-coated on 200 mm silicon wafers and baked at 240° C. for 60 seconds to form a SiARC film using ACT 8 Coating Track from Tokyo Electron Co. Film thickness of the SiARC Sample-A was measured by OptiProbe from Thermawave Co. and determined to be 35 nm. A carbon underlayer solution was prepared by mixing a condensation polymer of 1-naphthol and formaldehyde obtained from Gun Ei Chemical Co. (Mw=6066, Mn=2362), triethylammonium para-toluenesulfonate, a crosslinker (MYCOAT XM3629 from Nihon Cytec Industries), Polyfox® 656 surfactant, propylene glycol monomethyl ether and ethyl lactate. This underlayer solution (Underlayer-A) was filtered through 0.2 um PTFE, syringe filter and spin-coated on 200 mm silicon wafers and baked at 240° C. for 60 seconds to form a carbon underlayer film using ACT 8 Coating Track from Tokyo Electron Co. Film thickness of the carbon underlayer film was measured by OptiProbe from Thermawave Co. and determined to be 123nm. Blanket dry etching was applied to the SiARC and carbon underlayer films using a plasma dry etcher Plasma-therm RIE790 from Plasma-Therm Co. The dry etch conditions for SiARC films are; Gas type: O₂, Gas flow rate: 25 sccm, Power: 180 W, Pressure: 6 mTorr, Etch time: 60 seconds. The dry etch conditions for carbon underlayer films are; Gas type: CF₄, Gas flow rate:20 sccm, Power: 200 W Pressure: 30 mTorr, Etch time: 60 seconds.

II. Testing Method

1. Solution Appearance

The appearance of the remover solutions were determined using an automated imaging instrument which acquires digital images of 1 mL vials in controlled temperature environments using various mixing protocols. The solution appearance was measured at 20° C. and 60° C. The solution appearance was measured before and after mixing at both temperature to determine if the solution was multiple phases (opaque after mixing) or a single phase (clear after mixing).

2. Film Removal Testing

The film removal of the remover solutions was tested by exposing the solution to films coated on silicon wafers. A spring loaded compression device with a polyethylene gasket was used to hold a coated wafer in place. The spring loaded compression device divided the wafer into individual square wells so that multiple solutions can be independently tested at the same time. The wafer was inserted into the spring compression device and placed into the oven at 65° C. until preheated to 60° C. along with the sample solutions. The hydrogen peroxide was added to the solutions (if necessary) and the solutions were placed in the oven for an additional 3 minutes. The spring compression device with wafer and remover solutions were taken out of the oven. 750 microliters of each remover solution was dispensed into the individual wells using a micropipette and the device was placed back in the oven to keep the testing temperature at 60° C. After 5 minutes, the device was removed from the oven and the solutions were poured out of the sample wells. The wafer was rinsed thoroughly with water to remove the formulation from the film surface. The wafer was removed from the device, washed with water again, and dried with a nitrogen stream.

3. Film Thickness Measurement

The extent of swelling of the films as well as the efficacy of film removal, were assessed using variable-angle spectroscopic ellipsometry to measure the film thickness. A Variable-Angle Spectroscopic Ellipsometer (M-2000D, J.A. Woollam Co., Inc.) was used, which was equipped with both deuterium and quartz tungsten halogen lamps (λ=192.2 to 998.5 nm). Focusing optics were used during data collection. Data was collected for 6 seconds at five different incidence angles (45°, 50°, 55°, 60°, 65°, and 70°. Thickness data was determined by analyzing the measured Psi and Del curves using CompleteEASE software (J. A. Woollam Co., Inc., version 4.93f). The acquired data was fit to a film stack which included the silicon substrate, a thin native silicon oxide layer, and the overlaying film of interest. The films were first modeled above 400 nm using a Cauchy model, which assumes the film is non-adsorbing. From this fit of the wavelength-dependent refractive index of the film, the model was expanded to include light absorption at shorter wavelengths using a β-spline model.

IV. Results

Table 1 demonstrates the sensitivity of the microemulsion structure (single phase microemulsion versus multi-phase non-microemulsion) to different components in the formulation. Example 1 versus Comparative Example 1 shows that co-solvent must be present in high enough amount to form a stable microemulsion of water in oil. Example 2 versus Comparative Example 2 shows that the surfactant must be present in high enough amount to stabilize the aqueous phase in the microemulsion. Example 3 versus Comparative Example 3 shows that additional additives such as monoethanol amine impact the stability of the microemulsion. The microemulsion formulation must be finely tuned based on the exact choice of solvents, surfactant, base, and oxidizers.

TABLE 1
Solution phase behavior and appearance

| Component | Comp. 1 | Inv. 1 | Comp. 2 | Inv. 2 | Comp. 3 | Inv. 3 |
|---|---|---|---|---|---|---|
| DOWANOL PPh | 30 | 30 | 35 | 35 | 30 | 30 |
| Glycol Ether | | | | | | |
| Methoxytriglycol | 5 | 10 | 15 | 15 | 15 | 15 |
| Surfactant | 6 | 6 | 3 | 4 | 4 | 4 |
| Monoethanol amine | 4 | 4 | 4 | 4 | 2 | 4 |
| Water | 55 | 50 | 43 | 42 | 49 | 47 |
| Appearance | Opaque, | Clear, | Opaque, | Clear, | Opaque, | Clear, |
| | biphasic | single phase | biphasic | single phase | biphasic | single phase |

Numbers in table are grams.

Table 2 compares the removal efficiency of a microemulsion remover (Example 4) versus incomplete combinations of the same components which do not form a microemulsion. Comparative Example 4 contains only the solvents and results in no removal of the Si-ARC film. Comparative Example 5 contains only the aqueous phase (surfactant, water, base, oxidizer) and results in no removal of the Si-ARC film. Comparative Example 6 contains every component except the surfactant and results in no removal of the Si-ARC film. Comparative Example 7 contains every component except for the water-miscible solvent and results in no removal of the Si-ARC film. Example 4 contains all of the components resulting in a stable single phase microemulsion and results in 95% removal of the Si-ARC film. These examples demonstrate the importance of every component to the microemulsion structure and stability, and thus the effectiveness to remove the Si-ARC films.

TABLE 2
Importance of each component in microemulsion

| Component | Comp. 4 | Comp. 5 | Comp. 6 | Comp. 7 | Comp. 8 | Inv. 4 |
|---|---|---|---|---|---|---|
| DOWANOL PPh | 8.5 | 0 | 8.5 | 8.5 | 0 | 8.5 |
| Methoxytriglycol | 4.0 | 0 | 4.0 | 0 | 0 | 4.0 |
| Surfactant | 0 | 0.9 | 0 | 0.9 | 0 | 0.9 |
| Water | 0 | 6.4 | 7.3 | 6.4 | 9.0 | 6.4 |
| Ammonium hydroxide | 0 | 0.4 | 0.4 | 0.4 | 0.4 | 0.4 |
| Hydrogen peroxide | 0 | 0.7 | 0.7 | 0.7 | 0.6 | 0.7 |
| Si-ARC Percent Removed | 0 | 0 | 0 | 0 | 0 | 95 |

Numbers in table are grams. Percent removed is calculated by difference of the film thickness before and after removal with the solution divided by the original film thickness. A zero means that the film thickness remained the same and/or residue was left behind after treatment with the remover.

Table 3 compares a common remover solution versus three microemulsion remover formulations described in this invention to remove two photolithographic films: 1) an Si-ARC film on top of a carbon underlayer which has been exposed to an O₂ etch and 2) a carbon underlayer which has been exposed to a CF₄ etch. Comparative Example 9 is SC-1 which can remove 98% of the CF₄ etched carbon underlayer but cannot remove any of the O₂ etched Si-ARC film on carbon underlayer. The three microemulsion removers (Examples 5, 6, and 7) remove the 98% of the CF₄ etched carbon underlayer and 99% of the O₂ etched Si-ARC film on carbon underlayer. These examples demonstrate the advantage of the microemulsion removers versus the standard SC-1 solution.

TABLE 3
Multilayer film removal

| Component | Comp. 9 | Inv. 5 | Inv. 6 | Inv. 7 |
|---|---|---|---|---|
| DOWANOL PPh | 0 | 40.6 | 35.6 | 35.6 |
| Methoxytriglycol | 0 | 19.0 | 16.0 | 17.0 |
| Surfactant | 0 | 4.3 | 5.3 | 5.3 |
| Water | 90 | 30.5 | 36.6 | 35.9 |
| Ammonium hydroxide | 4 | 1.9 | 1.9 | 1.9 |
| Hydrogen peroxide | 6 | 3.6 | 4.6 | 4.3 |
| Percent Removed of Si ARC film | 0 | 99 | 99 | 99 |
| (as received already treated | | | | |
| with O₂ etch) | | | | |
| Percent Removed of Carbon | 98 | 98 | 98 | 98 |
| underlayer film (as received | | | | |
| already treated with CF₄ etch) | | | | |

Numbers in table are grams. Percent removed is the calculated by difference of the film thickness before and after removal with the solution divided by the original film thickness.

What is claimed is:

1. A microemulsion remover comprising, based on the total weight of the microemulsion remover, i) from 10% to 60%, at least one organic solvent, ii) from 10% to 50%, at least one co-solvent, iii) from 0.1% to 10%, at least one base, iv) from 0.1% to 10%, at least one oxidizer, v) from 0.1% to 10%, at least one surfactant, and vi) water;
wherein the organic solvents are chosen from aliphatic alcohols and aromatic alcohols with water solubility less than 10%, dialiphatic esters, aliphatic hydrocarbons, aromatic hydrocarbons, aliphatic diesters, aliphatic ketones with water solubility less than 10%, and aliphatic ethers; and wherein the co-solvents are aliphatic alcohols with water solubility greater than 10%.

2. The microemulsion remover according to claim 1 wherein the organic solvents are chosen from propylene glycol monomethyl ether acetate, dipropylene glycol monomethyl ether acetate, tripropylene glycol mono n-butyl ether, propylene glycol phenyl ether, propylene glycol diacetate, dipropylene glycol dimethyl ether, dithelyne glycol-butyl ether acetate, ethylene glycol n-butyl ether acetate, and ethylene glycol phenyl ether.

3. The microemulsion remover according to claim 1 wherein the organic solvents are chosen from propylene glycol phenyl ether and ethylene glycol phenyl ether.

4. The microemulsion remover according to claim 1 wherein the co-solvents are chosen from propylene glycol monomethyl ether, dipropylene glycol monomethyl ether, tripropylene glycol monomethyl ether, propylene glycol n-propyl ether, dipropylene glycol n-propyl ether, propylene glycol n-butyl ether, dipropylene glycol n-butyl ether, diethylene glycol ethyl ether, diethylene glycol methyl ether, diethylene glycol n-butyl ether, ethylene glycol propyl ether, ethylene glycol n-butyl ether, triethylene glycol monomethyl ether, triethylene glycol ethyl ether, and triethylene glycol n-butyl ether.

5. The microemulsion remover according to claim 1 wherein the co-solvents are chosen from triethylene glycol monomethyl ether, tripropylene glycol monomethyl ether, and dipropylene glycol monomethyl ether.

6. The microemulsion remover according to claim 1 wherein the surfactants are anionic surfactants chosen from salts of alkyl benzene sulfonates, alkyl toluene sulfonates, alkyl naphthyl sulfonates, petroleum sulfonates, alkyl sulfates, alkyl polyethoxy ether sulfates, paraffin sulfonates, alpha-olefin sulfonates, alpha-sulfocarboxylates and esters thereof, alkyl glyceryl ether sulfonates, fatty acid monoglyceride sulfates and sulfonates, alkyl phenol polyethoxy ether sulfates, 2-acyloxy-alkane-1-sulfonate, fatty acid salts, sulfated oils, and beta-alkyloxy alkane sulfonate.

7. The microemulsion remover according to claim 1 wherein the surfactants are anionic surfactants of formula RₓB—SO₃M, wherein R represents alkyl, x is 1 or 2, B is a biradical when x is 1 or is a triradical when x is 2 and which is derived from an aromatic moiety; and wherein M represents hydrogen or a cationic counterion and wherein the total number of carbons in the anionic surfactant of formula RₓB—SO₃M is from 18 to 30.

8. The microemulsion remover according to claim 1 wherein the anionic surfactants have a molecular weight greater than 400.

9. The microemulsion remover according to claim 1 wherein the bases are chosen from alkaline metal hydroxides, organic ammonium hydroxides, and alkanol amines

10. The microemulsion remover according to claim 1 wherein the oxidizers are chosen from organic or inorganic peroxides, ozone, dissolved oxygen, acids, and halogen gases.
